(19) United States
(12) Patent Application Publication
(10) Pub. No.: US 2017/0335105 A1
(43) Pub. Date: Nov. 23, 2017

(54) FLAME RETARDANT, REINFORCED POLYAMIDE-POLY(PHENYLENE ETHER) COMPOSITION

(71) Applicant: SABIC GLOBAL TECHNOLOGIES B.V., BERGEN OP ZOOM (NL)

(72) Inventors: Jung Ah Lee, Rensselaer, NY (US); Robert Walter Venderbosch, Bergen op Zoom (NL)

(21) Appl. No.: 15/527,494

(22) PCT Filed: Nov. 12, 2015
(86) PCT No.: PCT/US15/60352

§ 371 Date: May 17, 2017

Related U.S. Application Data
(60) Provisional application No. 62/081,268, filed on Nov. 18, 2014.

(51) Int. Cl. C08L 77/06

(52) U.S. Cl. CPC C08L 77/06; C08L 2201/02; C08L 2201/08

(57) ABSTRACT

Disclosed herein is a thermoplastic composition comprising 10 to 45 weight percent glass fiber, 5 to 15 weight percent of a metal dialkyl phosphinate, 1 to 5 weight percent melamine polyphosphate and a compatibilized blend formed from 20 to 60 weight percent of polyamide, 10 to 40 weight percent of polyphenylene ether, and 0.05 to 2 weight percent of a compatibilizing agent, wherein weight percent is based on the combined weight of the polyamide, polyphenylene ether, compatibilizing agent, glass fiber, metal dialkyl phosphinate and melamine polyphosphate, and the composition is free of borate compounds. The composition has a UL94 rating of V0 at a thickness of 1.5 millimeters.

### BACKGROUND OF THE INVENTION

Poly(phenylene ether) resins have been blended with polyamide resins to provide compositions having a wide variety of beneficial properties such as heat resistance, chemical resistance, impact strength, hydrolytic stability, and dimensional stability.

In some applications it is desirable to use poly(phenylene ether)/polyamide blends with good flame resistance. Unfortunately, this flame resistance is difficult to achieve for articles with lower thicknesses while maintaining mechanical properties. Moreover, it is particularly difficult to achieve flame retardancy in glass fiber reinforced thermoplastic compositions, because the presence of the reinforcing filler alters the combustion behavior of the composition compared to non-reinforced compositions. There remains a need for glass fiber reinforced poly(phenylene ether)/polyamide compositions that exhibit good flame retardancy, particularly in compositions having significant amounts of glass fiber.

### BRIEF SUMMARY OF EMBODIMENTS OF THE INVENTION

Disclosed herein is a thermoplastic composition comprising 10 to 45 weight percent glass fiber, 5 to 15 weight percent of a metal dialkyl phosphinate, 1 to 5 weight percent melamine polyphosphate and a compatibilized blend formed from 20 to 60 weight percent of polyamide, 10 to 40 weight percent of polyphenylene ether, and 0.05 to 2 weight percent of a compatibilizing agent, wherein weight percent is based on the combined weight of the polyamide, polyphenylene ether, compatibilizing agent, glass fiber, metal dialkyl phosphinate and melamine polyphosphate, and the composition is free of borate compounds. The composition has a UL94 rating of V0 at a thickness of 1.5 millimeters.

Also disclosed herein is a thermoplastic composition comprising 10 to 45 weight percent glass fiber, 8 to 15 weight percent of a metal dialkyl phosphinate, 2 to 5 weight percent melamine polyphosphate and a compatibilized blend formed from 20 to 60 weight percent of polyamide, 10 to 40 weight percent of polyphenylene ether, and 0.05 to 2 weight percent of a compatibilizing agent, wherein weight percent is based on the combined weight of the polyamide, polyphenylene ether, compatibilizing agent, glass fiber, metal dialkyl phosphinate and melamine polyphosphate, and the composition is free of borate compounds. The composition has a UL94 rating of V0 at a thickness of 0.4 millimeters. These and other embodiments are described in detail below.

### DETAILED DESCRIPTION OF THE INVENTION

Making glass reinforced poly(phenylene ether)/polyamide compositions flame retardant, particularly at elevated amounts of glass fiber, has proved challenging. Previous solutions, e.g., using a metal dialkylphosphinate as the sole flame retardant, have proved inadequate to provide robust flame retardance—particularly V0 flame retardance at thicknesses of 1.5 millimeters (mm) or less. Previous work suggested the use of a metal borate, such as zinc borate, to augment the flame retardance of the reinforced composition comprising a metal dialkyl phosphinate but this approach has been shown to be inadequate to provide a UL94 rating of V0 at a thickness of 1.5 millimeters or less. It has unexpectedly been discovered that the combination of a metal dialkyl phosphinate and melamine polyphosphate can yield a UL94 rating of V0 at a thickness of 1.5 millimeters or less.

The method utilizes a polyamide comprising polyamide-6, polyamide-6,6, and combinations thereof. In some embodiments, the polyamide is polyamide-6,6. The polyamide can have an amine end group concentration of 20 to 100 microequivalents per gram, or 30 to 80 microequivalents per gram, or 40 to 70 microequivalents per gram. Amine end group content can be determined by dissolving the polyamide in a suitable solvent and titrating with 0.01 normal hydrochloric acid (HCl) solution using a suitable indication method. The amount of amine end groups is calculated based the volume of HCl solution added to the sample, the volume of HCl used for the blank, the molarity of the HCl solution, and the weight of the polyamide sample. Polyamide-6 and polyamide-6,6 are commercially available from a number of sources and methods for their preparation are known.

The polyamide is used in an amount of about 20 to about 60 weight percent, based on the total weight of the composition (which is equivalent to the total weight of components melt blended to form the composition). Within this range, the polyamide amount can be greater than or equal to 22 weight percent, or greater than or equal to 24 weight percent, or, greater than or equal to 44 weight percent. Also within this range the polyamide amount can be less than or equal to 55 weight percent, or less than or equal to 52 weight percent, or, less than or equal to 48 weight percent.

In addition to the polyamide, the method utilizes a poly(phenylene ether). Suitable poly(phenylene ether)s include those comprising repeating structural units having the formula

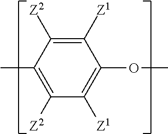

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

In some embodiments, the poly(phenylene ether) has an intrinsic viscosity of about 0.2 to about 1 deciliter per gram measured by Ubbelohde viscometer at 25° C. in chloroform. Within this range, the poly(phenylene ether) intrinsic viscosity can be about 0.2 to about 0.4 deciliter per gram, specifically about 0.25 to about 0.35 deciliter per gram.

In some embodiments, the poly(phenylene ether) is a poly(2,6-dimethyl-1,4-phenylene ether) prepared with a morpholine-containing catalyst, wherein a purified sample of poly(2,6-dimethyl-1,4-phenylene ether) prepared by dissolution of the poly(2,6-dimethyl-1,4-phenylene ether) in toluene, precipitation from methanol, reslurry, and isolation has a monomodal molecular weight distribution in the molecular weight range of 250 to 1,000,000 atomic mass units, and comprises less than or equal to 2.2 weight percent of poly(2,6-dimethyl-1,4-phenylene ether) having a molecular weight more than fifteen times the number average molecular weight of the entire purified sample. In some embodiments, the purified sample after separation into six equal poly(2,6-dimethyl-1,4-phenylene ether) weight fractions of decreasing molecular weight comprises a first, highest molecular weight fraction comprising at least 10 mole percent of poly(2,6-dimethyl-1,4-phenylene ether) comprising a terminal morpholine-substituted phenoxy group. The poly(2,6-dimethyl-1,4-phenylene ether) according to these embodiments is further described in U.S. Patent Application Publication No. US 2011/0003962 A1 of Carrillo et al.

In some embodiments, the poly(phenylene ether) is essentially free of incorporated diphenoquinone residues. In the context, “essentially free” means that the fewer than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues). For example, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone. However, such reequilibration reduces the molecular weight of the poly(phenylene ether). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in U.S. Patent Application Publication No. US 2009/0211967 A1 of Delsman et al. In an alternative approach utilizing the temperature-dependent solubility of diphenoquinone in toluene, a toluene solution containing diphenoquinone and poly(phenylene ether) can be adjusted to a temperature of about 25° C., at which diphenoquinone is poorly soluble but the poly(phenylene ether) is soluble, and the insoluble diphenoquinone can be removed by solid-liquid separation (e.g., filtration).

In some embodiments, the poly(phenylene ether) comprises 2,6-dimethyl-1,4-phenylene ether units, 2,3,6-trimethyl-1,4-phenylene ether units, or a combination thereof. In some embodiments, the poly(phenylene ether) is a poly(2,6-dimethyl-1,4-phenylene ether). In some embodiments, the poly(phenylene ether) comprises a poly(2,6-dimethyl-1,4-phenylene ether) having an intrinsic viscosity of about 0.2 to about 0.6 deciliter per gram, measured by Ubbelohde viscometer at 25° C. in chloroform. Within the range of about 0.2 to about 0.6 deciliter per gram, the poly(2,6-dimethyl-1,4-phenylene ether) having an intrinsic viscosity can be about 0.2 to about 0.4 deciliter per gram, specifically about 0.25 to about 0.35 deciliter per gram.

The poly(phenylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a random copolymer, a graft copolymer, an ionomer, or a block copolymer, as well as combinations thereof. The composition excludes poly(phenylene ether)-polysiloxane block copolymers. Accordingly, to the extent that the poly(phenylene ether) can be a block copolymer, it cannot be a poly(phenylene ether)-polysiloxane block copolymer.

The poly(phenylene ether) is used in an amount of about 10 to about 40 weight percent, based on the total weight of the composition (which is equivalent to the total weight of components melt blended to form the composition). Within this range, the poly(phenylene ether) amount can be greater than or equal to 15 weight percent, or greater than or equal to 20 weight percent. Also within this range the poly(phenylene ether) amount can be less than or equal to 35 weight percent, or less than or equal to 30 weight percent, or, less than or equal to 25 weight percent.

The compatibilized blend is formed using a compatibilizing agent. When used herein, the expression “compatibilizing agent” refers to polyfunctional compounds which interact with the poly(phenylene ether), the polyamide resin, or any combination thereof. This interaction may be chemical (e.g., grafting) and/or physical (e.g., affecting the surface characteristics of the dispersed phases). In either instance the resulting compatibilized poly(phenylene ether)/polyamide composition appears to exhibit improved compatibility, particularly as evidenced by enhanced impact strength, mold knit line strength and/or elongation. As used herein, the expression “compatibilized blend of poly(phenylene ether) and polyamide” refers to those compositions which have been physically and/or chemically compatibilized with a compatibilizing agent.

The compatibilizing agent comprises a polyfunctional compound that is one of two types. The first type has in the molecule both (a) a carbon-carbon double bond and (b) at least one carboxylic acid, anhydride, epoxy, imide, amide, ester group or functional equivalent thereof. Examples of such polyfunctional compounds include maleic acid; maleic anhydride; fumaric acid; maleic hydrazide; dichloro maleic anhydride; and unsaturated dicarboxylic acids (e.g. acrylic acid, butenoic acid, methacrylic acid, t-ethylacrylic acid, pentenoic acid). In some embodiments, the compatibilizing agent comprises maleic anhydride and/or fumaric acid.

The second type of polyfunctional compatibilizing agent compounds are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and salts thereof. Typical of this type of compatibilizing agents are the aliphatic polycarboxylic acids, acid esters and acid amides represented by the formula (IV):

(R^{I}O)ₘR(COOR^{II})ₙ(CONR^{III}R^{IV})ₛ (IV)

wherein R is a linear or branched chain saturated aliphatic hydrocarbon having 2 to 20, or, more specifically, 2 to 10 carbon atoms; R^{I} is hydrogen or an alkyl, aryl, acyl or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III} and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In some embodiments, the compatibilizing agent comprises citric acid. Illustrative of esters useful herein include, for example, acetyl citrate and mono- and/or distearyl citrates and the like. Suitable amides useful herein include, for example, N,N′-diethyl citric acid amide; N-phenyl citric acid amide; N-dodecyl citric acid amide; N,N′-didodecyl citric acid amide and N-dodecyl malic acid. Derivates include the salts thereof, including the salts with amines and the alkali and alkaline metal salts. Exemplary suitable salts include calcium malate, calcium citrate, potassium malate, and potassium citrate.

In some embodiments the compatibilizing agent comprises citric acid, maleic anhydride, fumaric acid or a combination thereof.

The foregoing compatibilizing agents may be added directly to the melt blend or pre-reacted with either or both the poly(phenylene ether) and polyamide. In some embodiments, at least a portion of the compatibilizing agent is pre-reacted, either in the melt or in a solution of a suitable solvent, with all or a part of the poly(phenylene ether). It is believed that such pre-reacting may cause the compatibilizing agent to react with the polymer and, consequently, functionalize the poly(phenylene ether). For example, the poly(phenylene ether) may be pre-reacted with maleic anhydride, fumaric acid and/or citric acid to form an anhydride and/or acid functionalized poly(phenylene ether) which has improved compatibility with the polyamide compared to a non-functionalized poly(phenylene ether).

The amount of the compatibilizing agent used will be dependent upon the specific compatibilizing agent chosen and the specific polymeric system to which it is added.

In some embodiments, the compatibilizing agent is employed in an amount of 0.05 to 2.0 weight percent, based on the total weight of the composition. Within this range the amount of compatibilizing agent may be greater than or equal to 0.1, or, more specifically, greater than or equal to 0.2, or, more specifically, greater than or equal to 0.5 weight percent. Also within this range the amount of compatibilizing agent may be less than or equal to 1.75, or, more specifically, less than or equal to 1.5 weight percent, or, more specifically less than or equal to 0.9 weight percent.

In some embodiments the compatibilizing agent comprises citric acid and the citric acid is used in an amount of 0.2 to 2.0 weight percent, based on the total weight of the composition.

Glass fibers include those based on E, A, C, ECR, R, S, D, and NE glasses, as well as quartz. The glass fiber may have a diameter of about 2 to about 30 micrometers, specifically about 5 to about 25 micrometers, more specifically about 10 to about 15 micrometers. The length of the glass fibers before compounding can be about 0.3 to about 5 millimeters, specifically about 0.5 to about 4 millimeters. The glass fiber can, optionally, include a so-called adhesion promoter to improve its compatibility with the thermoplastic composition. Adhesion promoters include chromium complexes, silanes, titanates, zirco-aluminates, propylene maleic anhydride copolymers, reactive cellulose esters and the like. Suitable glass fiber is commercially available from suppliers including, for example, Owens Corning, Johns Manville, and PPG Industries.

The glass fiber is used in an amount of about 10 to about 45 weight percent, based on the total weight of the composition (which is equivalent to the total weight of components melt blended to form the composition). Within this range the glass fiber can be present in an amount greater than or equal to 25 weight percent. Within this range the glass fiber amount can be less than or equal to 40 weight percent, or less than or equal to 35 weight percent, or, less than or equal to 15 weight percent.

As used herein, the term “metal dialkylphosphinate” refers to a salt comprising at least one metal cation and at least one dialkylphosphinate anion. In some embodiments, the metal dialkylphosphinate has the formula

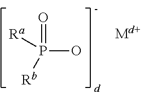

wherein R^{a} and R^{b} are each independently C₁-C₆ alkyl; M is calcium, magnesium, aluminum, or zinc; and d is 2 or 3. Examples of R^{a} and R^{b} include methyl, ethyl, n-propyl, isopropyl, n-butyl, tert-butyl, n-pentyl, and phenyl. In some embodiments, R^{a} and R^{b} are ethyl, M is aluminum, and d is 3 (that is, the metal dialkylphosphinate is aluminum tris(diethylphosphinate)).

The metal dialkylphosphinate is used in an amount of 5 to 15 weight percent, based on the total weight of the composition (which is equivalent to the total weight of components melt blended to form the composition). Within this range, the metal dialkylphosphinate amount can be greater than or equal to 8 weight percent, or greater than or equal to 10 weight percent. Also within this range the metal dialkylphosphinate amount can be less than or equal to 14 weight percent.

Melamine polyphosphate (CAS Reg. No. 56386-64-2) has the formula

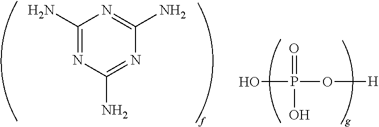

wherein g is, on average, greater than 2 and can have a value less than or equal to 10,000, and the ratio of f to g is 0.5:1 to 1.7:1, specifically 0.7:1 to 1.3:1, more specifically 0.9:1 to 1.1:1. It will be understood that this formula includes species in which one or more protons are transferred from the phosphate group(s) to the melamine group(s). In some embodiments g has an average value of greater than 2 to 10,000, specifically 5 to 1,000, more specifically 10 to 500. In some embodiments in which the nitrogen-containing flame retardant is melamine polyphosphate, g has an average value of greater than 2 to 500. Methods for preparing melamine polyphosphate are known in the art, and melamine polyphosphate is commercially available. For example, melamine polyphosphates may be prepared by reacting polyphosphoric acid and melamine, as described, for example, in U.S. Pat. No. 6,025,419 to Kasowski et al., or by heating melamine pyrophosphate under nitrogen at 290° C. to constant weight, as described in U.S. Pat. No. 6,015,510 to Jacobson et al.

The melamine polyphosphate is used in an amount of 1 to 5 weight percent, based on the total weight of the composition (which is equivalent to the total weight of components melt blended to form the composition). Within this range, the melamine polyphosphate amount can be greater than or equal to 1.5 weight percent, or greater than or equal to 2 weight percent. Also within this range the melamine polyphosphate amount can be less than or equal to 4.5 weight percent.

The composition can, optionally, further include one or more additives known in the thermoplastics art. For example, the composition can, optionally, further comprise an additive chosen from stabilizers, lubricants, processing aids, drip retardants, UV blockers, dyes, pigments, antioxidants, anti-static agents, mineral oil, metal deactivators, antiblocking agents, and the like, and combinations thereof. When present, such additives are typically used in a total amount of less than or equal to 2 weight percent, specifically less than or equal to 1 weight percent. In some embodiments, the composition excludes additives.

The composition can be made by dry blending the poly(phenylene ether), metal dialkyl phosphinate, compatibilizing agent, melamine polyphosphate and any additives and then adding the dry blend into an upstream port of an extruder. The dry blend is then melt mixed. The polyamide and glass fibers are added to the melt mix using separate downstream feeders. Typical melt mixing temperatures are 250-315° C.

The thermoplastic composition can be used to make electrical connectors, circuit breakers and the like. In some embodiments the thermoplastic composition can be used to make automotive electrical connectors. Automotive electrical connectors typically have low thicknesses and need chemical resistance to typical automotive fluids in addition to flame retardance.

The invention is further illustrated by the following non-limiting examples.

### COMPARATIVE EXAMPLES 1-5

Compositions were prepared using the components summarized in Table 1.

TABLE 1

| Component | Description |
|---|---|
| PPE | Poly(2,6-dimethyl-1,4-phenylene ether), CAS Reg. |
| | No. 25134 01 4, having an intrinsic viscosity of about |
| | 0.46 deciliter per gram measured in chloroform at 25° C.; |
| | obtained as PPO 646 from SABIC Innovative Plastics. |
| Citric | Citric acid having a minimum purity of 99 percent, CAS |
| acid | Reg. No. 77-92-9; obtained from Intercontinental |
| | Chemicals |
| Aluminum | CAS Reg. No. 225789-38-8; obtained from Clariant Ltd. |
| tris diethyl- | as Exolit OP1230 or as part of a mixture as described |
| phosphinate | below. Average particle diameter is 35 microns. |
| Exolit | A flame retardant mixture of about 63 weight percent |
| OP1312 | aluminum tris(diethylphosphinate), about 32 weight percent |
| | melamine polyphosphate, and about 5 weight percent |
| | zinc borate; obtained as EXOLIT OP 1312 from Clariant |
| MPP | Melamine polyphosphate, CAS Reg. No. 20208-95-1; |
| | obtained from BASF (Melapur 200) |
| MC | Melamine cyanurate, CAS Reg. No. 37640-57-6; obtained |
| | from BASF (Melapur MC25) |
| PA66 | Polyamide 6,6, CAS Reg. No. 32131-17-2, having a weight |
| | average molecular weight of about 68,000-75,000 atomic |
| | mass units (g/mol), in pellet form; obtained as |
| | VYDYNE 21Z from Ascend. |
| Irganox | A hindered phenolic antioxidant, octadecyl 3-(3′,5′- |
| 1076 | di-tert-butyl-4′-hydroxyphenyl)propionate, |
| | CAS Reg. No. 2082-79-3, obtained from |
| | Ciba Specialty Chemicals. |
| Cuprous | Cupric iodide having a minimum purity of 99%, |
| Iodide | obtained from S.D fine chemicals, CAS Reg. |
| | No. 7681-65-4. |
| Potassium | Potassium iodide having a minimum purity of 99%, |
| Iodide | obtained from Ranbaxy fine chemicals. CAS Reg. |
| | No. 7681-11-0. |
| Glass | ChopVantage ® HP 3540 E-glass with 3.2 mm in |
| Fiber | length and 10 micrometers in diameter from PPG |

Compositions are summarized in Table 3, where component amounts are in weight percent based on the total weight of the composition. Components were melt-blended in a Werner & Pfleiderer 30 millimeter internal diameter twin-screw extruder operated at 250 rotations per minute and a material throughput of about 18 kilograms/hour (40 pounds/hour). To prepare the compositions of Comparative Examples 1-5 a dry blend of poly(phenylene ether), metal dialkyl phosphinate, citric acid, and additives was fed into the upstream feed port of the extruder. The polyamide and glass fibers were fed into the downstream port using separate feeders. The extruder temperature was maintained at 260° C. (500° F.) in zone 1 (the most upstream zone), at 288° C. (550° F.) in zones 2-10, and at 299° C. (570° F.) at the die. The extrudate was cooled and pelletized.

Table 3 also summarizes flame retardancy test results for injection molded test samples. Flame retardancy of injection molded flame bars was determined according to Underwriter's Laboratory Bulletin 94 “Tests for Flammability of Plastic Materials, UL 94”, 20 mm Vertical Burning Flame Test. Before testing, flame bars with a thickness of 1.5 millimeters were conditioned at 23° C. and 50% relative humidity for at least 48 hours. In the UL 94 20 mm Vertical Burning Flame Test, a set of five flame bars is tested. For each bar, a flame is applied to the bar then removed, and the time required for the bar to self-extinguish (first afterflame time, t1) is noted. The flame is then reapplied and removed, and the time required for the bar to self-extinguish (second afterflame time, t2) and the post-flame glowing time (afterglow time, t3) are noted. To achieve a rating of V-0, the afterflame times t1 and t2 for each individual specimen must be less than or equal to 10 seconds; and the total afterflame time for all five specimens (t1 plus t2 for all five specimens) must be less than or equal to 50 seconds; and the second afterflame time plus the afterglow time for each individual specimen (t2+t3) must be less than or equal to 30 seconds; and no specimen can flame or glow up to the holding clamp; and the cotton indicator cannot be ignited by flaming particles or drops. To achieve a rating of V-1, the afterflame times t1 and t2 for each individual specimen must be less than or equal to 30 seconds; and the total afterflame time for all five specimens (t1 plus t2 for all five specimens) must be less than or equal to 250 seconds; and the second afterflame time plus the afterglow time for each individual specimen (t2+t3) must be less than or equal to 60 seconds; and no specimen can flame or glow up to the holding clamp; and the cotton indicator cannot be ignited by flaming particles or drops. To achieve a rating of V-2, the afterflame times t1 and t2 for each individual specimen must be less than or equal to 30 seconds; and the total afterflame time for all five specimens (t1 plus t2 for all five specimens) must be less than or equal to 250 seconds; and the second afterflame time plus the afterglow time for each individual specimen (t2+t3) must be less than or equal to 60 seconds; and no specimen can flame or glow up to the holding clamp; but the cotton indicator can be ignited by flaming particles or drops. Compositions not satisfying the V-2 requirements are considered to have failed.

The compositions were also tested for some or all of the physical properties shown in Table 2. The test methods are also shown in Table 2.

TABLE 2

| Property | Method |
|---|---|
| Heat deflection temperature | ISO 75; reported in ° C. |
| (HDT) | |
| Notches IZOD impact | ISO 180; reported in kiloJoules |
| strength at 23° C. | per meter² |
| Tensile Modulus | ISO 527; reported in megaPascals (MPa) |
| Tensile Stress @ break | ISO 527; reported in megaPascals (MPa) |
| Tensile Strain @ break | ISO 527; reported in % |
| Flexural Modulus | ISO 178; reported in megaPascals (MPa) |
| Specific gravity | ASTM D 792 |
| Melt Viscosity Index (MVI) | ISO 1133; reported in cc/10 min |

TABLE 3

| Material | CE1 | CE2 | CE3 | CE4 | CE5 |
|---|---|---|---|---|---|
| PPE | 24.00 | 24.00 | 24.00 | 24.00 | 24.00 |
| Citric acid | 0.70 | 0.70 | 0.70 | 0.70 | 0.70 |
| Aluminum tris | 12.00 | 12.00 | 12.00 | 12.00 | 12.00 |
| diethylphosphinate | | | | | |
| Irganox 1076 | 0.20 | 0.20 | 0.20 | 0.20 | 0.20 |
| Cuprous Iodide | 0.02 | 0.02 | 0.02 | 0.02 | 0.02 |
| Potassium Iodide | 0.23 | 0.23 | 0.23 | 0.23 | 0.23 |
| PA66 | 62.85 | 52.85 | 47.85 | 37.85 | 27.85 |
| Glass fibers | 0.00 | 10.00 | 15.00 | 25.00 | 35.00 |
| HDT@1.8 MPa (° C.) | 111.67 | 206.47 | 215.10 | 218.53 | 215.20 |
| IZOD-notched (kJ/m²) | 4.25 | 5.10 | 6.10 | 6.74 | 5.70 |
| Tensile modulus | 3295.00 | 5212.80 | 6431.40 | 9007.00 | 11998.00 |
| (MPa) | | | | | |
| Stress@break (MPa) | 61.72 | 91.20 | 108.20 | 129.10 | 117.86 |
| Strain@break (%) | 4.74 | 3.48 | 2.98 | 2.44 | 1.40 |
| Flexural modulus | 2935.33 | 4552.00 | 5736.00 | 8146.33 | 11342.67 |
| (MPa) | | | | | |
| Specific gravity | 1.15 | 1.22 | 1.25 | 1.34 | 1.43 |
| MVI@ 300° C./5 kg | 38.90 | 21.60 | 14.42 | 5.77 | na |
| UL 94 Rating@ | V0 | V1 | V1 | Failed | V1 |
| 1.5 mm | | | | | |

Comparative Examples 1 through 5 show that glass reinforced compositions using only a metal dialkyphosphinate as a flame retardant can, at best, achieve a V1 flame retardant rating at a thickness of 1.5 millimeters. A metal dialkyl phosphinate alone is insufficient in a glass reinforced poly(phenylene ether)/polyamide composition to provide flame retardancy of V0 at a thickness of 1.5 millimeters or less.

### EXAMPLES 1-10

Examples 1-10 were made using the components described in Table 1. The method of making the compositions was similar to that described above with regard to Comparative Examples 1-5 with the exception that melamine polyphosphate was added to the dry blend. Compositions and physical properties are shown in Table 4.

TABLE 4

| Material | EX1 | EX2 | EX3 | EX4 | EX5 | EX6 | EX7 | EX8 | EX9 | EX10 |
|---|---|---|---|---|---|---|---|---|---|---|
| PPE | 24.00 | 24.00 | 24.00 | 24.00 | 24.00 | 24.00 | 24.00 | 24.00 | 24.00 | 14.00 |
| Citric acid | 0.70 | 0.70 | 0.70 | 0.70 | 0.70 | 0.70 | 0.70 | 0.70 | 0.70 | 0.70 |
| Aluminum tris | 12.00 | 12.00 | 12.00 | 12.00 | 12.00 | 12.00 | 12.00 | 12.00 | 12.00 | 12.00 |
| diethylphospinate | | | | | | | | | | |
| MPP | 1.00 | 3.00 | 1.00 | 2.00 | 3.00 | 1.00 | 2.00 | 3.00 | 3.00 | 2.00 |
| Irganox 1076 | 0.20 | 0.20 | 0.20 | 0.20 | 0.20 | 0.20 | 0.20 | 0.20 | 0.20 | 0.20 |
| Cuprous Iodide | 0.02 | 0.02 | 0.02 | 0.02 | 0.02 | 0.02 | 0.02 | 0.02 | 0.02 | 0.02 |
| Potassium Iodide | 0.23 | 0.23 | 0.23 | 0.23 | 0.23 | 0.23 | 0.23 | 0.23 | 0.23 | 0.23 |
| PA66 | 51.85 | 49.85 | 46.85 | 45.85 | 44.85 | 36.85 | 35.85 | 34.85 | 24.85 | 45.85 |
| Glass fibers | 10.00 | 10.00 | 15.00 | 15.00 | 15.00 | 25.00 | 25.00 | 25.00 | 35.00 | 25.00 |
| HDT@1.8 MPa (° C.) | 200.1 | 202.5 | 220.03 | 209.03 | 205.0 | 207.1 | 207.2 | 207.6 | 207.0 | 229.3 |
| IZOD-notched (kJ/m²) | 3.4 | 3.2 | 5.2 | 4.4 | 4.1 | 4.3 | 3.7 | 4.0 | 4.4 | 5.6 |
| Tensile modulus (MPa) | 4997.2 | 5605.2 | 6565.8 | 6686.4 | 5829.1 | 7681.6 | 7792.4 | 8290.8 | 11036.0 | 9289.6 |
| Stress@break (MPa) | 60.0 | 86.5 | 100.8 | 99.4 | 61.9 | 66.2 | 68.3 | 84.0 | 90.1 | 117.9 |
| Strain@break (%) | 1.4 | 2.2 | 2.5 | 2.1 | 1.3 | 1.1 | 1.1 | 1.3 | 1.1 | 2.1 |
| Flexural modulus (MPa) | 4901.7 | 5156.3 | 6289.0 | 6502.7 | 5422.0 | 8037.0 | 8167.7 | 8312.3 | 11368.3 | 8237.7 |
| Specific gravity | 1.22 | 1.23 | 1.26 | 1.27 | 1.27 | 1.33 | 1.33 | 1.33 | 1.43 | 1.36 |
| MVI@ 300° C./5 kg | 55.7 | 93.6 | 36.50 | 33.80 | 47.70 | 16.6 | 25.7 | 38.4 | na | 52.4 |
| UL 94 Rating@ 1.5 mm | V0 | V0 | V0 | V0 | V0 | V0 | V0 | V0 | V0 | V0 |
| UL 94 Rating@ 0.4 mm | V1 | V0 | V1 | V0 | V0 | V0 | V0 | V0 | V0 | V0 |

Examples 1-10 show that as little as 1.0 weight percent melamine polyphosphate has a dramatic effect on flame retardance, increasing the flame retardancy at 1.5 millimeters to V0 and yielding a V1 or better rating at a thickness of 0.4 millimeters.

### COMPARATIVE EXAMPLES 6-9

Comparative Examples 6-9 were made using the components described in Table 1. The method of making the compositions was similar to that described above with regard to Comparative Examples 1-5 with the exception that melamine cyanurate, when used, was added to the dry blend. Exolit OP 1312, when used, was added to the dry blend. Because Exolit OP1312 is a mixture the amounts of the components of the mixture are also shown. Compositions and physical properties are shown in Table 5.

TABLE 5

| Material | CE6 | CE7 | CE8 | CE9 |
|---|---|---|---|---|
| PPE | 24.00 | 14.00 | 21.00 | 19.00 |
| Citric acid | 0.70 | 0.70 | 0.40 | 0.40 |
| Aluminum tris | 12.00 | 12.00 | | |
| diethylphosphinate | | | | |
| Exolit OP1312 | | | 10.00 | 14.00 |
| Aluminum | | | 6.3** | 8.82** |
| tris(diethylphosphinate)** | | | | |
| Melamine polyphosphate** | | | 3.2** | 4.48** |
| Zinc borate** | | | 0.5** | 0.7** |
| MC | 3.00 | 3.00 | | |
| Irganox 1076 | 0.20 | 0.20 | 0.20 | 0.20 |
| Cuprous Iodide | 0.02 | 0.02 | 0.02 | 0.02 |
| Potassium Iodide | 0.23 | 0.23 | 0.23 | 0.23 |
| PA66 | 44.85 | 44.85 | 60.15 | 58.15 |
| Glass fibers | 15.00 | 25.00 | 8.00 | 8.00 |
| HDT@1.8 MPa (° C.) | 212.7 | 231.9 | 203.0 | 197.2 |
| IZOD-notched (kJ/m²) | 5.0 | 6.8 | 4.6 | 4.0 |
| Tensile modulus (MPa) | 6488.0 | 9095.0 | 5061.4 | 5207.0 |
| Stress@break (MPa) | 98.3 | 119.2 | 105.3 | 98.3 |
| Strain@break (%) | 2.6 | 2.2 | 3.5 | 3.1 |
| Flexural modulus (MPa) | 5761.0 | 8207.3 | 4629.7 | 4799.3 |
| MVI@ 300° C./5 kg | 54.1 | 39.4 | 65.2 | 69.6 |
| UL 94 Rating@ 1.5 mm | V1 | Failed | Failed | V1 |

**Component of the Exolit OP1312

Comparative examples 6 and 7 show that the combination of a metal dialkyl phosphinate and melamine cyanurate is insufficient to achieve a flame retardance of V0 at a thickness of 1.5 millimeters. Comparative Examples 8 and 9 shown that the combination of a metal dialkyl phosphinate and zinc borate is also insufficient to achieve a V0 rating at a thickness of 1.5 millimeters. This points out the unexpected efficacy of the combination of a metal dialkyl phosphinate and melamine polyphosphate. In the prior art, melamine cyanurate and zinc borate were both used as flame retardant synergists with metal dialkyl phosphinates and seen as equivalent to melamine polyphosphate. Surprisingly, compositions with melamine polyphosphate give unexpectedly better flame retardance than compositions with melamine cyanurate or zinc borate.

Embodiment 1: A thermoplastic composition comprising 10 to 45 weight percent glass fiber, 5 to 15 weight percent of a metal dialkyl phosphinate, 1 to 5 weight percent melamine polyphosphate and a compatibilized blend formed from 20 to 60 weight percent of polyamide, 10 to 40 weight percent of polyphenylene ether, and 0.05 to 2 weight percent of a compatibilizing agent, wherein weight percent is based on the combined weight of the polyamide, polyphenylene ether, compatibilizing agent, glass fiber, metal dialkyl phosphinate and melamine polyphosphate, and the composition is free of borate compounds.

Embodiment 2: The composition of Embodiment 1 comprising 10 to 45 weight percent glass fiber, 8 to 15 weight percent of a metal dialkyl phosphinate, and 2 to 5 weight percent melamine polyphosphate.

Embodiment 3: The composition of Embodiment 1 comprising 10 to 15 weight percent glass fiber, 8 to 15 weight percent metal dialkyl phosphinate, 2 to 5 weight percent melamine polyphosphate, 44 to 52 weight percent polyamide and 10 to 40 weight percent polyphenylene ether, based on the combined weight of the polyamide, polyphenylene ether, compatibilizing agent, glass fiber, metal dialkyl phosphinate and melamine polyphosphate.

Embodiment 4: The composition of Embodiment 1 comprising 25 to 35 weight percent glass fiber, 24 to 48 weight percent polyamide, 10 to 25 weight percent polyphenylene ether, 8 to 15 weight percent metal dialkyl phosphinate, 1 to 5 weight percent melamine polyphosphate, based on the combined weight of the polyamide, polyphenylene ether, compatibilizing agent, glass fiber, metal dialkyl phosphinate and melamine polyphosphate.

Embodiment 5: The composition of any one of the preceding embodiments, wherein the compatibilized blend is the product of melt blending polyphenylene ether, polyamide and a compatibilizing agent.

Embodiment 6: The composition of any one of the preceding embodiments, wherein the compatibilizing agent comprises citric acid, fumaric acid, maleic anhydride, or a combination thereof.

Embodiment 7: The composition of Embodiment 6, wherein the compatibilizing agent is citric acid.

Embodiment 8: The composition of any one of embodiments 1 to 7, wherein the polyamide comprises polyamide 6,6.

Embodiment 9: The composition of any one of embodiments 1 to 8, wherein the poly(phenylene ether) is a poly(2,6-dimethyl-1,4-phenylene ether).

Embodiment 10: The composition of any one of embodiments 1 to 9, wherein the metal dialkyl phosphinate is aluminum tris(diethylphosphinate).

Embodiment 11: The composition of Embodiment 1 comprising 22 to 55 weight percent of polyamide 66; 20 to 30 weight percent poly(2,6-dimethyl-1,4-phenylene ether), 0.2 to 2.0 weight percent citric acid, 10 to 35 weight percent glass fiber, 10 to 14 weight percent of aluminum tris(diethylphosphinate), and 2 to 4.5 weight percent melamine polyphosphate, wherein weight percent is based on the combined weight of the polyamide, polyphenylene ether, compatibilizing agent, glass fiber, metal dialkyl phosphinate and melamine polyphosphate.

Embodiment 12: The composition of any one of embodiments 1 to 11, wherein the glass fiber has an average length of 0.3 to 5 millimeters and an average diameter of 2 to 30 micrometers.

Embodiment 13: An electrical connector comprising the thermoplastic composition of any of Embodiments 1 to 12.

Embodiment 14: The electrical connector of Embodiment 13, wherein the electrical connector is an automotive electrical connector.

Embodiment 15: The electrical connector of Embodiment 13 wherein the electrical connector is a circuit breaker.

Embodiment 16: A method of making a thermoplastic composition comprising dry blending 10 to 40 weight percent of a poly(phenylene ether), 0.05 to 2 weight percent of a compatibilizing agent, 1 to 5 weight percent melamine polyphosphate, and 5 to 15 weight percent of a metal dialkyl phosphinate to form a dry blend, melt blending the dry blend to form a melt mix, adding 20 to 60 weight percent of polyamide and 10 to 45 weight percent glass fibers to the melt mix, weight percent is based on the combined weight of the polyamide, polyphenylene ether, compatibilizing agent, glass fiber, metal dialkyl phosphinate and melamine polyphosphate.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising 10 to 45 weight percent glass fiber, 5 to 15 weight percent of a metal dialkyl phosphinate, 1 to 5 weight percent melamine polyphosphate and a compatibilized blend formed from 20 to 60 weight percent of polyamide, 10 to 40 weight percent of polyphenylene ether, and 0.05 to 2 weight percent of a compatibilizing agent, wherein weight percent is based on the combined weight of the polyamide, polyphenylene ether, compatibilizing agent, glass fiber, metal dialkyl phosphinate and melamine polyphosphate, and the composition is free of borate compounds.

2. The composition of claim 1, comprising 10 to 45 weight percent glass fiber, 8 to 15 weight percent of a metal dialkyl phosphinate, and 2 to 5 weight percent melamine polyphosphate.

3. The composition of claim 1, comprising 10 to 15 weight percent glass fiber, 8 to 15 weight percent metal dialkyl phosphinate, 2 to 5 weight percent melamine polyphosphate, 44 to 52 weight percent polyamide and 10 to 40 weight percent polyphenylene ether, based on the combined weight of the polyamide, polyphenylene ether, compatibilizing agent, glass fiber, metal dialkyl phosphinate and melamine polyphosphate.

4. The composition of claim 1, comprising 25 to 35 weight percent glass fiber, 24 to 48 weight percent polyamide, 10 to 25 weight percent polyphenylene ether, 8 to 15 weight percent metal dialkyl phosphinate, 1 to 5 weight percent melamine polyphosphate, based on the combined weight of the polyamide, polyphenylene ether, compatibilizing agent, glass fiber, metal dialkyl phosphinate and melamine polyphosphate.

5. The composition of claim 1, wherein the compatibilized blend is the product of melt blending polyphenylene ether, polyamide and a compatibilizing agent.

6. The composition of claim 1, wherein the compatibilizing agent comprises citric acid, fumaric acid, maleic anhydride, or a combination thereof.

7. The composition of claim 6, wherein the compatibilizing agent is citric acid.

8. The composition of claim 1, wherein the polyamide comprises polyamide 66.

9. The composition of claim 1, wherein the poly(phenylene ether) is a poly(2,6-dimethyl-1,4-phenylene ether).

10. The composition of claim 1, wherein the metal dialkyl phosphinate is aluminum tris(diethylphosphinate).

11. The composition of claim 1, comprising 22 to 55 weight percent of polyamide 66; 20 to 30 weight percent poly(2,6-dimethyl-1,4-phenylene ether), 0.2 to 2.0 weight percent citric acid, 10 to 35 weight percent glass fiber, 10 to 14 weight percent of aluminum tris(diethylphosphinate), and 2 to 4.5 weight percent melamine polyphosphate, wherein weight percent is based on the combined weight of the polyamide, polyphenylene ether, compatibilizing agent, glass fiber, metal dialkyl phosphinate and melamine polyphosphate.

12. The composition of claim 1, wherein the glass fiber has an average length of 0.3 to 5 millimeters and an average diameter of 2 to 30 micrometers.

13. An electrical connector comprising the thermoplastic composition of claim 1.

14. The electrical connector of claim 13, wherein the electrical connector is an automotive electrical connector.

15. The electrical connector of claim 13, wherein the electrical connector is a circuit breaker.

16. A method of making a thermoplastic composition comprising dry blending 10 to 40 weight percent of a poly(phenylene ether), 0.05 to 2 weight percent of a compatibilizing agent, 1 to 5 weight percent melamine polyphosphate, and 5 to 15 weight percent of a metal dialkyl phosphinate to form a dry blend, melt blending the dry blend to form a melt mix, adding 20 to 60 weight percent of polyamide and 10 to 45 weight percent glass fibers to the melt mix, weight percent is based on the combined weight of the polyamide, polyphenylene ether, compatibilizing agent, glass fiber, metal dialkyl phosphinate and melamine polyphosphate.
